(19) United States
(12) Patent Application Publication
(10) Pub. No.: US 2015/0314241 A1
(43) Pub. Date: Nov. 5, 2015

(54) CONSTRUCTIONS FOR FLUID MEMBRANE SEPARATION DEVICES

(71) Applicant: 3M INNOVATIVE PROPERTIES COMPANY, Saint Paul,, MN (US)

(72) Inventors: Jonathan F. Hester, Hudson, WI (US); Gustavo H. Castro, Cottage Grove, MN (US); Thomas Herdtle, Inver Grove Heights, MN (US); Jimmy M. Le, St. Paul, MN (US); Liming Song, Woodbury, MN (US)

(73) Assignee: 3M INNOVATIVE PROPERTIES COMPANY, Saint Paul, MN (US)

(21) Appl. No.: 14/650,042

(22) PCT Filed: Nov. 22, 2013
(86) PCT No.: PCT/US2013/071379

§ 371 Date: Jun. 5, 2015

Related U.S. Application Data
(60) Provisional application No. 61/736,729, filed on Dec. 13, 2012.

(51) Int. Cl. B01D 65/08; B01D 63/08

(52) U.S. Cl. CPC B01D 65/08; B01D 63/082; B01D 2319/02; B01D 2313/08; B01D 2313/143; B01D 2321/20

(57) ABSTRACT

Described herein is a construction comprising (a) a support sheet having a base, comprising (i) a plurality of rails extending from the base wherein each rail of the plurality of rails extends continuously down a length of the support sheet and each rail comprises a first side surface and an opposing second side surface and a top surface; and (ii) a plurality of first protrusions extending from the base, wherein the plurality of first protrusions are located between the plurality of rails; and (b) a selectively permeable membrane having a first major membrane surface contacting at least the top surface of at least two rails enclosing a flow channel having a height extending between the base of the support sheet and the first major membrane surface, wherein the plurality of protrusions change the height of the flow channel along its length along the longitudinal axis of the flow channel.

### TECHNICAL FIELD

The present disclosure generally relates to constructions for fluid membrane separation devices.

### BACKGROUND

Fluid membrane devices include membrane modules that generally fall into three membrane categories: tubular, hollow fiber, and flat sheet porous membranes. Flat sheet porous membrane modules can be assembled in pleated cartridges, spirally-wound modules, or plate-and-frame configurations. Plate-and-frame flat sheet membrane modules are typically easier to clean than other types of membrane modules.

Support sheets may be used to keep a space between two flat-sheet membranes to provide conveyance of fluid to or from the space between the membranes via a manifold connected to the flat-sheet membrane modules. Support sheets may be in the form of a permeable mesh or net, paper mesh, non-woven or woven-fiber based material, a corrugated polymer film or an extruded polymer sheet comprising flow channels.

Net-type spacers play a dual role in commercially available filtration membrane modules, such as cross-flow filtration or reverse osmosis separation equipment. Such spacers not only keep adjacent membrane layers apart so as to form a feed channel therebetween, but they also promote eddies in the fluid element adjacent to the membrane surface, so as to keep the membrane surface relatively clean. Such spacers are commercially available, for example nonwoven and woven netting fabrics made by Delstar Technologies, Inc. under the designations “DELNET” and “NALTEX”.

### SUMMARY

The alternative membrane constructions of the present disclosure may have, among other things, improved performance and/or are lower in cost to manufacture or use. For example, there is a desire to have a membrane separation module having improved resistance to clogging and/or improved mass transfer of desired constituents across a selectively permeable membrane.

In one aspect, a construction is provided comprising:
(a) a support sheet having a base, comprising
   (i) a plurality of rails extending from the base wherein each rail of the plurality of rails extends continuously down a length of the support sheet and each rail comprises a first side surface, an opposing second side surface and a top surface; and
   (ii) a plurality of first protrusions extending from the base, wherein the plurality of first protrusions are located between the plurality of rails; and
(b) a selectively permeable membrane having a first major membrane surface contacting at least the top surface of at least two rails enclosing a flow channel having a height extending between the base of the support sheet and the first major membrane surface, wherein the plurality of protrusions extending from the base change the height of the flow channel along its length in the longitudinal direction.

In another aspect, a fluid membrane separation unit comprising: a series of repeating layers, each layer comprising
(a) a support sheet having a base, comprising
   (i) a plurality of rails extending from the base wherein each rail of the plurality of rails extends continuously down a length of the support sheet and each rail comprises a first side surface and an opposing second side surface and a top surface; and
   (ii) a plurality of first protrusions extending from the base, wherein the plurality of first protrusions are located between the plurality of rails; and
(b) a selectively permeable membrane having a first major membrane surface contacting at least the top surface of at least two rails enclosing a flow channel having a height extending between the base of the support sheet and the first major membrane surface, wherein the plurality of protrusions change the height of the flow channel along its length in the longitudinal direction.

In yet another aspect, a method of making a construction is provided comprising: (a) providing a nip roll comprising a negative of a design; (b) extruding a polymer through a nip comprising the nip roll to impart the design into the first major surface of the polymer to create a support sheet having the design on the first major surface; (c) contacting the first major surface of the support sheet with a selectively permeable membrane to form the construction.

The above summary is not intended to describe each embodiment. The details of one or more embodiments of the invention are also set forth in the description below. Other features, objects, and advantages will be apparent from the description and from the claims.

### BRIEF DESCRIPTION OF DRAWINGS

FIG. 1a is a perspective view of an exemplary fluid membrane separation unit according to one embodiment of the present disclosure and FIG. 1b is an exploded cross-sectional view of a construction comprising a support sheet according to one embodiment of the present disclosure and a selectively permeable membrane;

FIG. 2 is an exploded perspective view of a support sheet according to one embodiment of the present disclosure;

FIG. 3 is an exploded perspective view of a support sheet according to one embodiment of the present disclosure;

FIG. 4 is an exploded perspective view of a support sheet according to one embodiment of the present disclosure;

FIG. 5a is an exploded perspective view of a support sheet according to one embodiment of the present disclosure and FIG. 5b is a corresponding top-view;

FIG. 6 is an exploded perspective view of a support sheet according to one embodiment of the present disclosure;

FIG. 7 is an exploded perspective view illustrating one embodiment for assembling a module comprising multiple support sheets and selectively permeable membrane layers;

FIG. 8 is an exploded perspective view of a support sheet illustrative of that used as Comparative Support Sheet A used in the examples of the present disclosure; and

FIG. 9 is an exploded side-view of a sinusoidal support sheet illustrative of that used as Comparative Support Sheets B and C used in the examples of the present disclosure.

### DETAILED DESCRIPTION

### Definitions

As used herein, the terms

“a”, “an”, and “the” are used interchangeably and mean one or more; and

“and/or” is used to indicate one or both stated cases may occur, for example A and/or B includes (A and B) and (A or B).

As used herein, the term “microporous” refers to porous films, membranes or film layers having an average pore size of 0.05 to 3.0 microns as measured by bubble point pore size ASTM-F-316-03 (2011) “Standard Test Methods for Pore Size Characteristics of Membrane Filters by Bubble Point and Mean Flow Pore Test”.

As used herein, the term “ultraporous” refers to films, membranes or film layers having an average pore size of up to 10 micrometers, or even 0.001 to 0.05 micrometers as measured by bubble point pore size test ASTM-F-316-03 (2011).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure provides constructions and articles using the same, which are used in fluid membrane separation devices for filtering and/or extracting desired or undesired constituents from fluid streams.

As used herein, a fluid membrane separation device comprises a fluid membrane separation unit (or module) and housing, which is used to direct fluid(s) to and from the fluid membrane separation unit. The fluid membrane separation unit comprises at least one support sheet and a selectively permeable membrane. The fluid membrane separation unit comprises at least one inlet and at least one outlet wherein fluids are directed into and out of the fluid membrane separation unit.

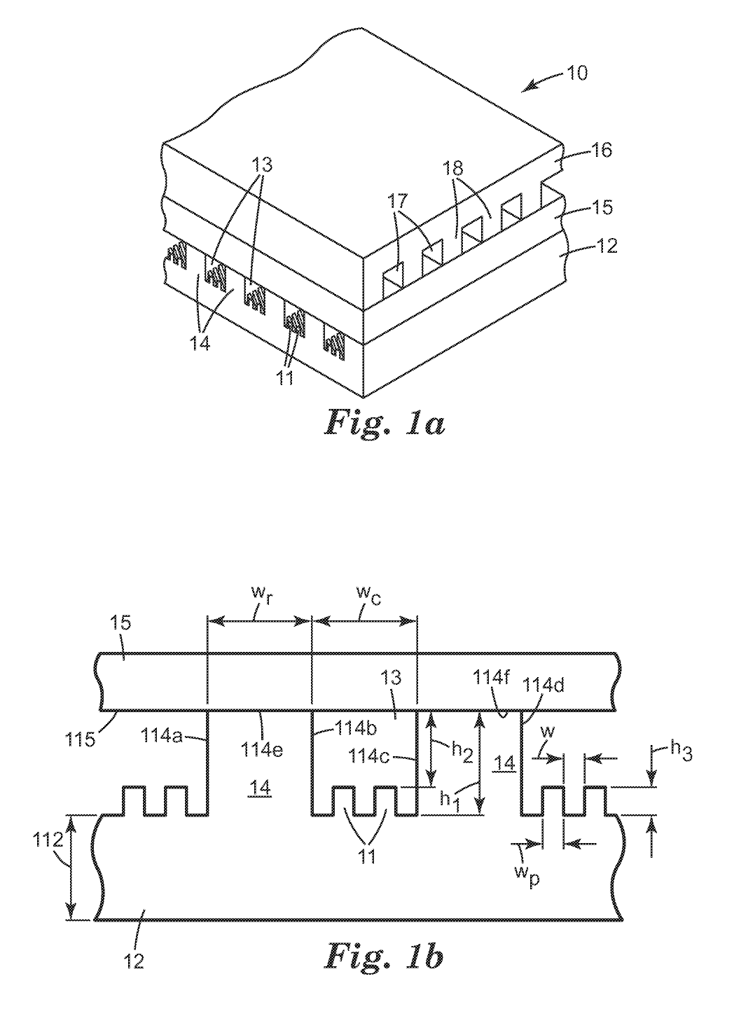

Shown in FIG. 1a is fluid membrane separation unit 10, which comprises support sheets 12 and 16 and selectively permeable membrane 15 therebetween. Support sheet 12 comprises a plurality of rails 14 and a plurality of flow channels 13. Support sheet 16 also comprises a plurality of rails 18 and a plurality of flow channels 17. The surfaces of opposing rails define the sides of a flow channel, which has a net direction of flow along the longitudinal axis of the flow channel and parallel to the length of the rails. Shown in FIG. 1a, the plurality of flow channels 17 of support sheet 16 have a direction of net flow different than that of the plurality of flow channels 13 of support sheet 12. In one embodiment of FIG. 1a, a first fluid is conveyed through the plurality of flow channels 13, selected constituents from the first fluid pass through selectively permeable membrane 15 and into the plurality of flow channels 17.

The support sheet of the present disclosure is used to not only provide structural support to the membrane separation unit and provide conveyance of fluid (e.g., liquid) to and/or from the selectively permeable membrane, but also to improve the performance of the fluid membrane separation unit, for example by lowering the pressure drop, improving the mass transfer of constituents across the membrane, and reducing fouling of the selectively permeable membrane. This is accomplished by using the support sheets disclosed herein.

In the present disclosure, at least one support sheet of the fluid membrane separation unit comprises a plurality of protrusions in addition to the plurality of rails. FIG. 1b is an exploded cross-sectional view taken from FIG. 1a depicting an exemplary construction of the present disclosure. FIG. 1b comprises support sheet 12 and selectively permeable membrane 15. Support sheet 12 comprises base 112; a plurality of rails 14 extending from base 112; and a plurality of protrusions 11 extending from base 112. Each rail comprises a first side surface (e.g., 114a, 114c), an opposing second side surface (e.g., 114b, 114d), and a top surface (e.g., 114e and 1140. The plurality of protrusions 11 are located between the plurality of rails 14 and protrude (or project) from the base of the support sheet. Selectively permeable membrane 15 has a first major surface 115, which contacts at least the top surface of at least two rails enclosing flow channel 13. Flow channel 13 is defined by the first major surface 115 of the selectively permeable membrane, a first side surface of a rail (e.g., 114c) and an opposing side surface of an adjacent rail (e.g., 114b) and base 112. From the base of the support sheet to the first major surface of the selectively permeable membrane the flow channel has a height h₁ as shown in FIG. 1b. From the top of the protrusion to the first major surface of the selectively permeable layer, the flow channel has a height h₂ as shown in FIG. 1b. Also shown in FIG. 1b is height h₃ which is the height of the protrusion; wₚ which is the width of the protrusion; w which is the width between adjacent protrusions; wᵣ which is the width of the rail; and w_{c} is the width of the flow channel. In the present disclosure, the height of the flow channel along the longitudinal axis (or length of the flow channel) changes. For example, the height of the flow channel may change by at least 30%, 40%, 50%, 60%, 70% or even 80%.

Support Sheet

In the present disclosure, it has been discovered that by fabricating protrusions into the flow channels of the support sheet, the performance of the membrane separation unit may improve, e.g., improved mass or heat transfer, reduced fouling, etc.

The plurality of protrusions extending from the base of the support sheet introduce features which create perturbations in the laminar flow within the flow channel. Thus, the plurality of protrusion enables chaotic laminar flow, organized laminar flow, helical flow, and/or turbulent flow in the flow channels.

The design of the plurality of protrusions extending from the base of the support sheet is not particularly limited, so long as the protrusions provide a flow having a directional component not parallel with the net flow direction in the flow channel. Preferably, the plurality of protrusions circulate fluid flow within the flow channels to disrupt the fluid boundary layer at the surface of the adjacent selectively permeable membrane (e.g., first major surface 115). In one embodiment, the plurality of protrusions, comprise at least 3, 5, 8, 10, 15, 20, 50, 100, 200, 500, or even 1000 protrusions per mm in the longitudinal axis direction within a flow channel.

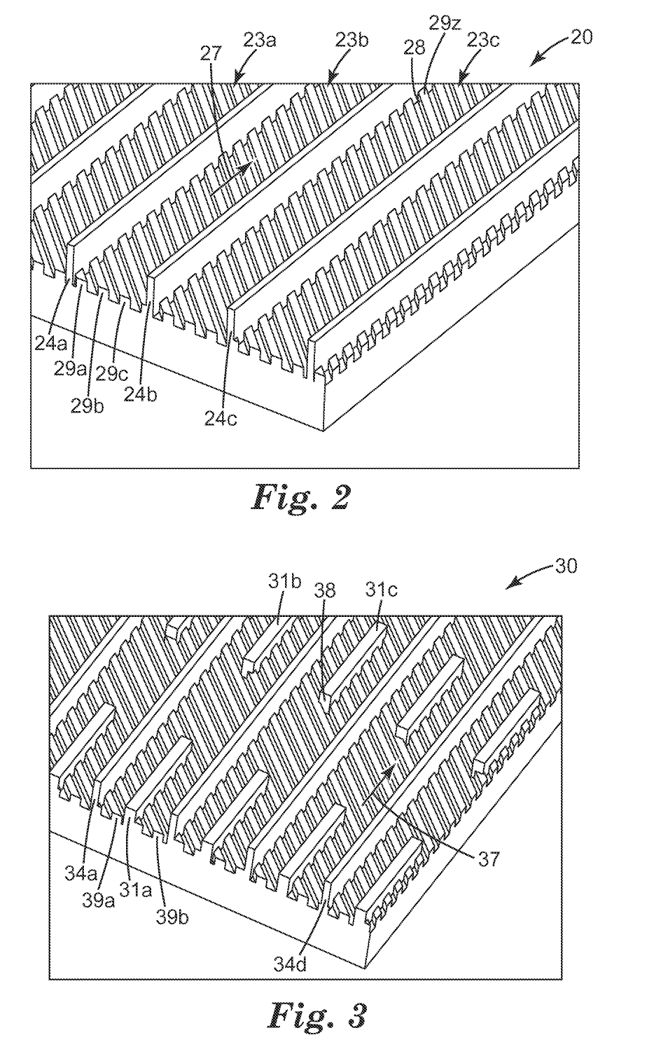

Exemplary designs of support sheets comprising a plurality of protrusions are shown in FIGS. 2-6 below.

Shown in FIG. 2 is a schematic view of support sheet 20. Support sheet 20 comprises a plurality of rails (24a, 24b, 24c, . . . ) and flow channels (23a, 23b, 23c, . . . ) extending from the base of the support sheet.

The side surfaces of two adjacent rails, 24a and 24b, form flow channel 23b, which is open to the outside of the membrane separation unit at the ends of the support sheet. The flow channels have a net flow direction along the longitudinal axis of the flow channel. The arrow 27 depicted in FIG. 2 shows the longitudinal axis of the flow channel.

In addition to the plurality of rails, support sheet 20 also comprises a plurality of first protrusions (29a, 29b, 29c . . . ). The protrusions are made by a series of projections extending from the base of the support sheet, which are diagonal to the direction of the rail length.

In one embodiment, the protrusions (29a, 29b, . . . ) in the plurality of first protrusions have a height (i.e., h₃) as measured from the top of the protrusion to the base of the support sheet of at least 50, 60, 70, 80, 90, or even 100 micrometers and at most 200, 300, 400, 500, 600, or even 700 micrometers. In one embodiment, the protrusions in the plurality of first protrusions have a width (wₚ) of at least 50, 60, 70, 80, 90, or even 100 micrometers and at most 200, 300, 400, 500, 600, or even 700 micrometers. In one embodiment, the distance between adjacent protrusions (w) in the plurality of first protrusions is at least 50, 60, 70, 80, 90, or even 100 micrometers and at most 200, 300, 400, 500, 600, or even 700 micrometers.

In one embodiment of the present disclosure, a single protrusion of the plurality of protrusions is a member that is discontinuous along the length of the flow channel in the longitudinal axis of the flow channel. In another embodiment of the present disclosure, a protrusion of the plurality of protrusions extends continuously from a first side surface of a first rail to an opposing side surface of an adjacent rail, wherein the first side surface and the opposing side surface extend continuously along the length of the flow channel on opposite sides of the flow channel. For example, as shown in FIG. 2, the protrusions are continuous between rails 24a and 24b, but do not extend continuously along the longitudinal axis of the flow channel.

In one embodiment of the present disclosure, a protrusion of the plurality of protrusions comprises a member having at least one leading edge oriented in a direction not substantially parallel with the longitudinal axis of the flow channel. For example, referring to FIG. 2, arrow 27 depicts the longitudinal axis of the flow channel. Protrusion 29z has leading edge 28, which is not substantially parallel with the longitudinal axis of the flow channel. Substantially parallel means that the leading edge is within −10 to +10 degrees from the longitudinal axis of the flow channel.

In one embodiment, a protrusion of the plurality of protrusions refers to a member extending from the base of the support sheet which has a height h₃ less than h₁. In one embodiment, h₃ has an average height of less than 90%, 80%, 70%, 60%, 50%, 40%, or even 30% of h₁ and an average height of at least 5%, 10%, 15% or even 20% of h₁.

In one embodiment of the present disclosure, a protrusion of the plurality of protrusions is a member that comprises a leading edge (28) arranged at an angle (e.g., 5, 10, 15, 20, 25, 30, 35, 40, 45, 50, 55, 60, 65, 70, 75, 80, or even 85 degrees) with respect to the longitudinal axis of the flow channel. For example, see leading edge 28 of FIG. 2.

In one embodiment of the present disclosure, the plurality of protrusions comprise a series of substantially parallel protrusions extending from the base of the support sheet as shown by protrusions 29a, 29b, and 29c of FIG. 2.

In one embodiment, the support sheet of the present disclosure comprises more than one plurality of protrusions. Shown in FIG. 3 is another embodiment of a support sheet comprising two pluralities of protrusions. Support sheet 30 comprises a plurality of first protrusions (39a, 39b . . . ), which are projections at an angle to the direction of the plurality of rails (34a, 34d . . . ), such as those disclosed in FIG. 2 above, as well as a plurality of second protrusions (31a, 31b, 31c . . . ), which are projections that are parallel to the longitudinal axis of the flow channel, which is represented by arrow 37 in FIG. 3, but have a height, h₃ less than h₁. Although not wanting to be limited by theory, it is believed that the plurality of first protrusions in FIG. 3 (i.e., projections at an angle to the longitudinal axis of the flow channel) assist with cleaning the surface of the selectively permeable membrane, while the plurality of second protrusions in FIG. 3 (i.e., taller projections having a leading edge which is parallel to the longitudinal axis of the flow channel) assist in dispersing material from the center of the flow channel to the perimeter of the flow channel and vice versa.

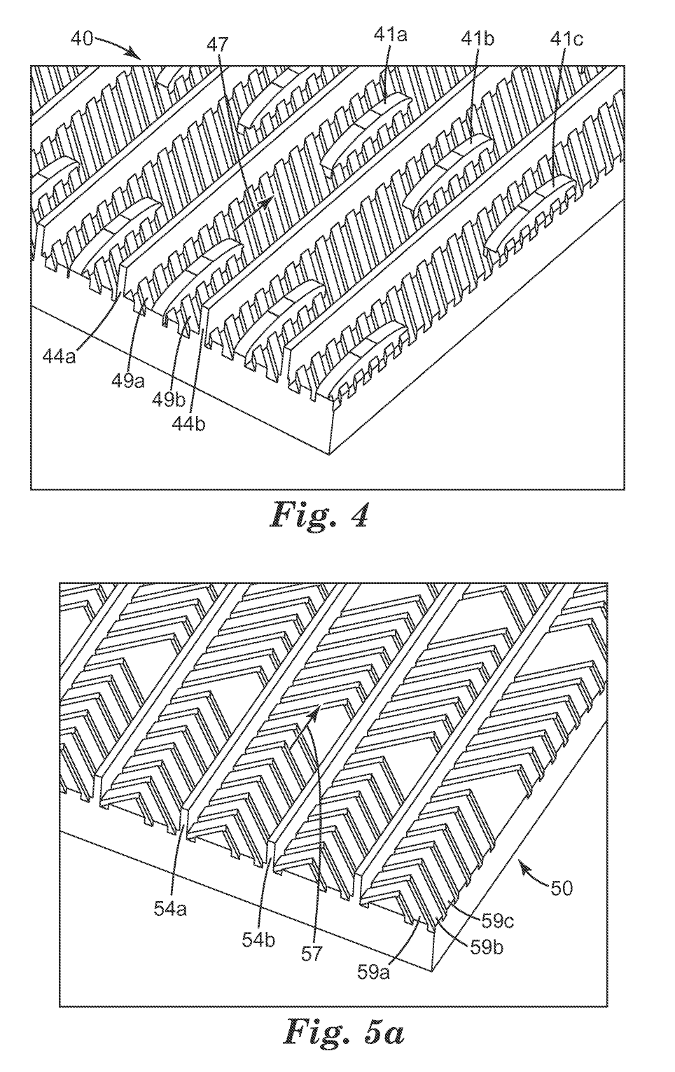

The profile of the second protrusion which is in the axial flow direction may be rectangular (as shown in FIG. 3), triangular, curvilinear (as shown in FIG. 4), or some combination thereof when viewed at 90 degrees to the longitudinal axis of the flow channel. The second protrusions may comprise a leading edge, 38, which can be rectangular (as shown in FIG. 3), square, or curvilinear. The leading edge may be perpendicular to longitudinal axis of the flow channel or may be at another angle relative to the longitudinal axis of the flow channel. In one embodiment, there may be no leading edge on the second protrusions. For example, FIG. 4 comprises second protrusions have a curvilinear profile in the axial flow direction, wherein the apex of the curvilinear profile comprises a linear portion which then slopes downward until it contacts the base of the support sheet or the plurality of first protrusions. The longitudinal axis of the flow channel of support sheet 40, is represented by arrow 47 in FIG. 4.

In one embodiment, the protrusions (e.g., 31a, 31b, . . . or 41a, 41b, 41c, . . . ) in the plurality of second protrusions have a height (h₃) between the base of the support sheet and the apex of the protrusions of at least 20, 30, 40, 50, 60, 70, 80, 90, or even 100 micrometers and at most 200, 300, 400, 500, or even 600 micrometers. In one embodiment the difference in height between the protrusions in the plurality of second protrusions and the protrusions in the plurality of second protrusions is at least 5, 10, 20, 40, 60, 80, 100, 200, 400, or even 500 micrometers. In one embodiment, the protrusions in the plurality of second protrusions have a width (wₚ) of at least 50, 60, 70, 80, 90, or even 100 micrometers and at most 200, 300, 400, 500, 600, or even 700 micrometers. In one embodiment, the protrusions in the plurality of second protrusions have a length in the distance of the longitudinal axis direction of at least 1000, 2000, 3000, 4000, or even 5000 micrometer and at most to 7000, 8000, 9000, 10000 or even 12000 micrometers. In one embodiment, the distance between adjacent protrusions (i.e., end of one protrusion to leading edge or start of adjacent protrusion) in the plurality of second protrusions is at least 1000, 2000, 3000, 4000, or even 5000 micrometer and at most to 7000, 8000, 9000, 10000 or even 12000 micrometers. As shown in FIGS. 3 and 4, the second protrusions are spaced equidistant from the side walls of the flow channel, however, alternate embodiments can be envisioned, wherein the protrusions of the plurality of second protrusions are spaced off center in the flow channel or wherein the distance between the side wall of the flow channel and the protrusions of the plurality of second protrusions are varied, having some second protrusions which are closer to a first side surface of the flow channel and some which are further from the first side surface of the flow channel.

Shown in FIG. 5a is another embodiment of a support sheet of the present disclosure and a corresponding top view FIG. 5b. Support sheet 50 comprises a plurality of rails (54a, 54b, . . . ) and a plurality of protrusions (59a, 59b, 59c, . . . ) arranged in a staggered herringbone configuration. The protrusions are made by a series of staggered asymmetrical projections, which are at an angle from the longitudinal axis of the flow channel. The longitudinal axis of the flow channel of support sheet 50, is represented by arrow 57 in FIG. 5. Distance l depicted in FIG. 5b is the axial distance from the top of the “V” to the side wall. FIG. 5b, depicts an asymmetrical herringbone construction, which is staggered, wherein the distance l is varied. In one embodiment l may be equidistant from the walls of the flow channel.

In one embodiment, the protrusions (59a, 59b, . . . ) in the plurality of protrusions in FIG. 5 have a height (h₃) of at least 50, 60, 70, 80, 90, or even 100 micrometers and at most 200, 300, 400, 500, 600, or even 700 micrometers. In one embodiment, the protrusions in the plurality of protrusions have a width (wₚ) of at least 50, 60, 70, 80, 90, or even 100 micrometers and at most 200, 300, 400, 500, 600, or even 700 micrometers. In one embodiment, the distance (w) between adjacent protrusions in the plurality of protrusions is at least 50, 60, 70, 80, 90, or even 100 micrometers and at most 200, 300, 400, 500, 600, or even 700 micrometers.

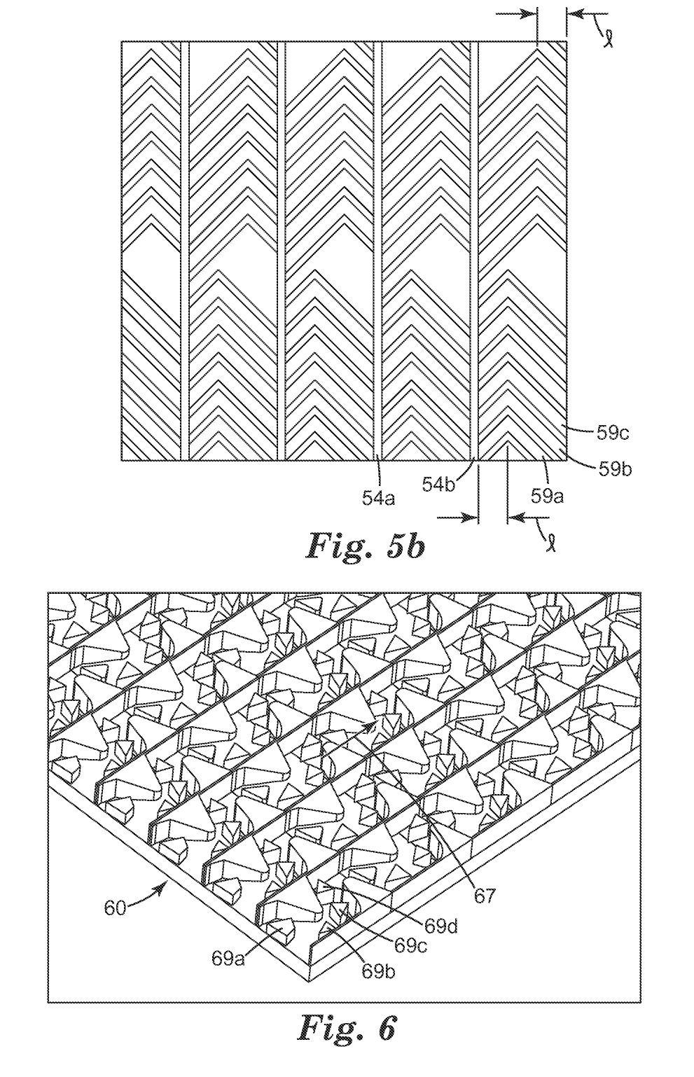

Although the flow channels thus far have been depicted as linear, alternative shapes, sizes or configurations of the flow channels are permissible. For example, the flow channels may have a tortuous path (e.g., a zig zag pattern) or a maze or curved configuration. Shown in FIG. 6 is yet another embodiment of a support sheet of the present disclosure. The flow channels of support sheet 60 comprise a sinusoidal flow path, wherein the direction of net flow path is depicted by arrow 67. Furthermore, the bottom of the flow channel comprises an undulating pattern in the longitudinal direction comprising parabolic ridges having a certain peak height (which is not depicted in FIG. 6). In addition to this plurality of protrusions, support sheet 60 further comprises plurality of protrusions (69a, 69b, 69c, 69d, . . . ), which create flow obstacles and interrupt flow. The open cross-sectional area of the flow channels decreases and increases when moving along the longitudinal axis of the flow channel. The design and placement of the protrusions are selected to obstruct fluid flow through the flow channel, with each protrusion forcing a portion of the fluid to change direction within the flow channel. The “open cross-sectional area of the flow channel” is the area, in a plane that is oriented generally orthogonal to the longitudinal axis of the flow channel at a selected location, through which fluid can flow through a flow channel. In a generally rectangular flow channel, the open cross-sectional area may be defined by the height of the flow channel as measured between the base of the support sheet and the first major surface of the selectively permeable membrane and the width of the flow channel as measured between the opposing side edges. The open cross-sectional area of the channel can be decreased by, e.g., flow restrictions that decrease the height of the channel. It may be preferred that, as compared to the maximum open cross-sectional area of a given channel, the flow restrictions reduce the open cross-sectional area of the channel by, e.g., about 25% or more, in some instances 50% or more, or even 75% or more. The flow obstacles preferably cause fluids flowing through the channel to change direction while the flow restrictions cause the fluid to accelerate and decelerate as it flows past the flow restrictions. The change in the open cross-sectional area can be provided by narrowing the channel in one or more dimensions in that orthogonal plane. For example, the narrowing may occur in the height of the channel (as measured between the base of the support sheet and the first major surface of the selectively permeable membrane) and/or across the width of the flow channel. For example, the height of the channel in FIG. 6 may narrow from 200 to 500 micrometers in height and 300 to 800 micrometers in width across the flow channel.

In one embodiment, the protrusions (69a, 69b, . . . ) in the plurality of protrusions in FIG. 6 have a height (h₃) of at least 300, 350, 400, 425, 450, 475, or even 500 micrometers and at most 700, 750, 800, 825, 850, 875, or even 900 micrometers. In one embodiment, the protrusions in the plurality of protrusions have a width (w) of at least 200, 250, 300, or even 350 micrometers and at most 400, 450, 500, 550, 600, or even 650 micrometers. In one embodiment, the distance between adjacent protrusions (w) in the plurality of protrusions is at least 200, 250, 300, 350, 400, or even 450 micrometers and at most 500, 550, 600, 650, 700, 750, 800, or even 850 micrometers. In one embodiment the protrusions in the plurality of protrusions comprise an angle along at least one major surface of the protrusion as shown in some of the protrusions depicted in FIG. 6.

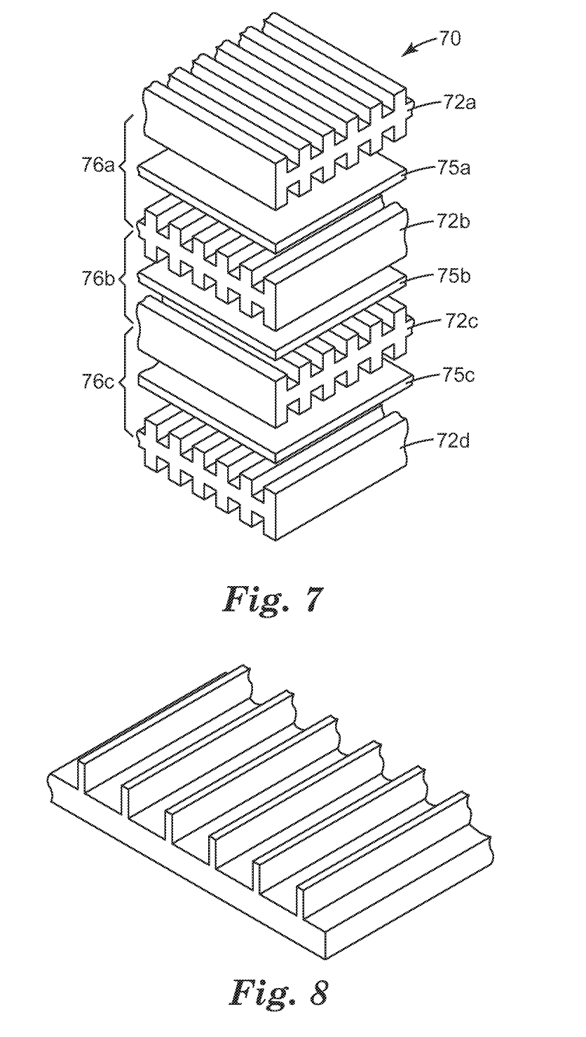

In addition to having just one major surface of the support sheet comprising a plurality of rails as shown in FIG. 1, both major surfaces of the support sheet may comprise a plurality of rails as shown, for example, in the support sheets 72a, 72b, 72c, and 72 d of FIG. 7 (note: the plurality of protrusions is not depicted in this figure for simplicity purposes although the plurality may be in one or both sides of the support sheet).

In one embodiment, the support sheet comprises a plurality of rails on each major surface, wherein the plurality of rails on the first major surface form a plurality of first flow channels with a first flow direction and the plurality of rails on the second major surface form a plurality of second flow channels with a second flow direction, wherein the net fluid flow in the second flow direction is substantially the same (i.e., less than 20, 10, or even 5 degrees different) as the net fluid flow in the first flow direction. In one embodiment, the rails of the first surface are aligned with the plurality of rails on the second surface. In another embodiment, the rails of the first surface may be positioned in an offset relationship relative to the rails on the second surface.

In one embodiment, the support sheet comprises a plurality of rails on each major surface wherein the plurality of rails on the first surface form a plurality of first flow channels with a first flow direction and the plurality of rails on the second surface form a plurality of second flow channels with a second flow direction, wherein the net fluid flow in the second flow direction is different (i.e., greater than 25, 45, or even 50 degrees) from the net fluid flow in the first flow direction. In one embodiment, the net fluid flow in the second flow direction is orthogonal (or about 90 degrees) to the net fluid flow in the first flow direction.

If the support sheet comprises a plurality of rails on both major surfaces, the plurality of protrusions in the flow channels may be on one major surface of the support sheet or on both major surfaces of the support. If there is a plurality of protrusions on both major surfaces of the support sheet, the design of the plurality of protrusions may or may not be the same on the opposing sides of the support sheet.

The width of the flow channels can vary depending on the application (e.g., the fluid used (liquid versus gas), the constituent being separated, and the complexity of the matrix being separated). In one embodiment, the width of the flow channel (w_{c}) is at least 100 μm, 200 μm, 250 μm, 300 μm, or even 500 μm; at most 1500 μm, 2000 μm, 5000 μm, 10000 μm, 15000 μm, 20000 μm, or even 25000 μm.

In one embodiment, the rail height (h₁) is at least 100 μm, 150 μm, 250 μm, 300 μm, or even 500 μm; at most 1000 μm, 1500 μm, 2000 μm, 2500 μm, or even 3000 μm. In one embodiment, the rail width (wᵣ) is at least 20 μm, 25 μm, 40 μm, 50 μm, 75 μm, or even 100 μm; at most 250 μm, 500 μm, 600 μm, 750 μm, or even 1000 μm. In one embodiment, the base layer thickness (112) is at least 100 μm, 150 μm, 250 μm, 300 μm, or even 500 μm; at most 1000 μm, 1500 μm, 2000 μm, 2500 μm, or even 3000 μm.

The support sheet may be made from any polymer known in the art including for example, silicones, fluorinated polymers (such as ethylene-chlorotrifluoroethylene polymers and polyvinylidene fluoride). In one embodiment, the support sheet comprises a thermoplastic polymer, meaning that the support sheet is made from a polymer that melts or is able to be pliable upon heating and then retains a shape upon cooling. In another embodiment, the support sheet comprises a polymer resulting from the curing of a prepolymeric composition by application to the prepolymeric composition of thermal energy or radiation, e.g., ultraviolet light. Such methods to create structured films by curing a prepolymeric composition are disclosed in U.S. Pat. No. 6,136,412 (Spiewiak et al.), herein incorporated by reference in its entirety.

In one embodiment, the support sheet comprises a thermoplastic polymer at the top surface of the plurality of rails. The thermoplastic polymer at the distal end of the rails can be used to bond or adhere the support sheet to the selectively permeable membrane. Such constructions may enable improved mechanical and dimensional stability of the membrane separation module. Such techniques of having a thermoplastic polymer on the distal tip of the rails and making a membrane separation module are disclosed in U.S. Appl. No. 61/702,942, filed 19 Sep. 2012, herein incorporated by reference in its entirety.

The thermoplastic polymer may be selected from: polypropylene and copolymers thereof, polyethylene and copolymers thereof, polyolefin elastomers, ethylene vinyl acetate copolymers, ethylene vinyl acetate terpolymers, styrene-ethylene/butylene-styrene block copolymers, polyurethanes, polybutylene (polyisobutylene), polybutylene copolymers, polyisoprene, polyisoprene copolymers, acrylate, silicones, natural rubber, and mixtures thereof.

Such thermoplastic polymers are commercially available, such as ultra low density polyethylene such as that available under the trade designation “ENGAGE” from DuPont Dow Elastomers, LLC of Wilmington, Del., and ethylene vinyl acetate copolymers and terpolymers such as that available under the trade designation “ELVAX” from Dupont Dow Elastomers, LLC.

In general, any suitable technique and apparatus for polymer processing into shapes, known in the art, may be used to prepare a support sheet of the present invention. Such techniques include continuous processes such as profile extrusion, cast film extrusion, embossing, and cast and cure. Casting processes can utilize structured molding surfaces to replicate the shape of the support structure. Non-continuous polymer processes such as injection molding, thermo-forming, and stereolithography can also be used to form the support structures of this invention.

In a preferred embodiment, a molding tool, e.g., a cylindrical roll, is made comprising the negative of the desired surface structure of the support sheet. A film of molten thermoplastic is brought into contact with the molding tool, causing the desired surface structure to become embossed on the surface of the thermoplastic film. In another preferred embodiment referred to as “cast and cure,” a prepolymeric composition is provided, comprising monomers, oligomers, and/or short chain polymers, which is capable of being reacted further to increase its polymeric character and/or molecular weight. A film of the prepolymeric composition is brought into contact with a molding tool, causing the desired surface structure to become embossed in the prepolymeric composition. The prepolymeric composition is then further reacted, or cured, by application of thermal energy or radiation. In yet another embodiment, a stereolithographic process is used to fabricate a microstructured support sheet using a curable prepolymeric composition. Although stereolithography offers flexibility in design modification, it is often costly, and the higher throughput methods described above are preferred.

In one embodiment, the design (comprising at least the plurality of protrusions) may be created on one or both major surfaces of the support sheet.

Selectively Permeable Membrane

The selectively permeable membrane is used to provide a membrane for selective passage or transport of at least one constituent of a fluid mixture through the structure while selectively precluding transport of other constituent(s). Exemplary selectively permeable membranes include microporous membranes, ultraporous membranes, non-woven webs, woven webs, perforated or micro-perforated polymer films, and the like. When using multiple layers of the selectively permeable membrane, each layer may be the same or different depending on the application. For example, the selectively permeable membrane can comprise a porous membrane and a fibrous or non-woven layer.

The selectively permeable membrane may be hydrophilic or hydrophobic depending on the requirements of separation, such as gas-solid, gas-liquid, gas-gas, liquid-solid, or liquid-liquid separation requirements. Some non-exhaustive examples of materials that may be used as part of the selectively permeable membrane include: polysulfones, polyethersulfones, cellulose polymers, polyamides (e.g., nylon), polycarbonate, polyolefins (e.g., polypropylene, polyethylene), ethylene vinyl alcohol copolymer, polyvinyl chloride, fluoropolymers (e.g., polyvinylidene fluoride, ethylene-chlorotrifluoroethylene copolymers, polytetrafluoroethylene), polyacrylonitrile, composites of ionic polymers containing ionic liquids, such as those disclosed in U.S. Pat. Publ. No. 2012/0186446 (Bara et al.), or any copolymers or other combinations thereof. In one embodiment, the surface of the membrane is treated (e.g., coated) to provide additional surfaces properties (such as hydrophobicity, or selectivity to a certain compound).

In one embodiment, the selectively permeable membrane may be ultraporous or microporous with pore sizes that may range from about 0.001 μm (micrometer) to about 10 μm. Preferably, the pore size of the selectively permeable membrane is less than about 3.0 μm.

In one embodiment, the selectively permeable membrane is a non-woven. Exemplary non-wovens include: blown microfiber (BMF) filter media, which typically has 1-10 μm fiber size; nanofiber filter media, which can be produced by a BMF process or electrospinning process and typically have a fiber size less than 1 μm; and spunbond filter media, which are typically greater than 10 μm fiber size. Spunbond media can be laminated to (or co-formed with) BMF or nanofiber media to give a composite with increased strength.

BMF, nanofiber, and spunbond nonwoven media can be produced out of a variety of polymers such as for example, polyolefins, polyesters, nylons, and other polymers.

The thickness of the selectively permeable membrane can vary depending on the application. In one embodiment, the thickness of the selectively permeable membrane is at least 10 μm, 20 μm, 25 μm, 30 μm, 35 μm or even 40 μm; at most 75 μm, 100 μm, 125 μm, 150 μm or even 200 μm, depending on the application.

Membrane Separation Module

The first major surface of the support sheet is contacted with the selectively permeable membrane to form a membrane construction. In one embodiment, the first major surface of the support sheet is bonded with the selectively permeable membrane to form a membrane construction. In one embodiment, the bonding of the first major surface of the support sheet with the selectively permeable membrane may be an adhesive bond wherein an adhesive is coated onto the first major surface of the support sheet and/or the selectively permeable membrane and then contacted with each other to bond. In another embodiment, the bonding of the first major surface of the support sheet with the selectively permeable membrane occurs via a thermoplastic polymer located at least on the distal end of the rail, which when heated flows and then bonds the first major surface of the support sheet with the selectively permeable membrane. Such a technique is disclosed in U.S. Appl. No. 61/702,942, filed 19 Sep. 2012, herein incorporated by reference in its entirety.

In one embodiment, the fluid membrane separation unit of the present disclosure comprises two support sheets and a selectively permeable membrane therebetween, wherein at least one of the support sheets comprises a plurality of protrusions. Alternating layers of support sheets and selectively permeable membrane layers can be stacked as shown in FIG. 7 to make a membrane separation module 70 comprising alternating support sheets (72a, 72b, 72c, and 72d) and selectively permeable membranes (75a, 75b, and 75c). In one embodiment, a membrane separation module comprises a plurality of support sheets of the present disclosure and selectively permeable membrane layers, comprising at least 2, 3, 4, 6, 8, 10, 15, 20, 25, 50, 100, 150 or even 200 or more of these layer pairs wherein a layer comprises a selectively permeable membrane layer and at least one support sheet of the present disclosure. Layer pairs are shown in FIG. 7 as 76a, 76b, and 76c.

A plurality of support sheets and selectively permeable membranes may be stacked directly upon one another, or optionally layered with a second material to form the membrane separation module. The second material may be selected to provide additional properties or capabilities, for example, additional support, prefilter, etc. to the support sheet and selectively permeable membrane. Exemplary second materials include: metals, glass, ceramics, polymers and non-woven or woven fabric material.

In one embodiment, the support sheets may be stacked such that a plurality of flow channels on the support sheet are oriented in at least 1 or even 2 different flow directions.

In one embodiment, a first layer pair has the plurality of flow channels oriented in a first flow direction, while a second layer pair has the plurality of flow channels oriented in a second flow direction, which is different from the first. In another embodiment, the layer comprises at least 2 support sheets on opposite sides of the selectively permeable membrane, wherein the first support sheet has a plurality of flow channels oriented in a first flow direction and the second support sheet has a plurality of flow channels oriented in a second flow direction, which is different from the first flow direction.

In one embodiment, the direction of net fluid flow between the first and second flow directions are substantially orthogonal (meaning between 45 to 135 degrees different; 70 to 110 degrees different; 80 to 100 degrees different; or even 85 to 95 degrees different), although other orientations may be contemplated.

The constructions of the present disclosure can be used to treat waste water, filter particulates, and perform liquid/liquid, liquid/gas or gas/gas extraction. In one embodiment, the construction of the present disclosure can be used to separate alcohols from water (such as ethanol, butanol, etc).

The support sheet comprising the plurality of protrusions may be located on the sample inlet side of the membrane separation unit (e.g., permeate side or feed side), the analyte outlet side of the membrane separation unit (e.g., retentate side), or both the sample inlet and the analyte outlet side of the membrane separation unit. Which side of the selectively permeable membrane the support sheet comprising the plurality of protrusions is located may be dictated by the composition of the sample matrix (e.g., contains constituents which may foul the selectively permeable membrane), the viscosity of the fluid, the flow rate of the fluid and the diffusivity of the constituents, etc.

Because the membrane separation construction of the present disclosure is used in fluid applications with at least one fluid inlet and one fluid outlet, the various flow directions and inlets and outlets must be managed and isolated.

Two directional flow can be created in which a first fluid flows through the module in a first flow direction, passing through the flow channels and contacting the selectively permeable membrane. The permeate of interest (e.g., an analyte, liquid, particle, gas, or vapor) may pass through the selectively permeable membrane and into the flow channels on the other side of the selectively permeable membrane. For manufacturing and material handling ease, it is preferable that the flow channels, which collect the permeate run in a direction different than the feed fluid. Although in one embodiment, the direction of the permeate is the same as that of the feed fluid.

To prevent leakage, the membrane separation module can be fabricated to block the peripheral (or outer) flow channels.

In one embodiment, a material may be applied through at least one of the flow channels at the periphery or edges of the support sheet. This material may be an adhesive or a thermoplastic polymer. Exemplary adhesive include hot melt adhesives, epoxy adhesives, urethane adhesives, acrylic adhesives, silicone adhesives, polyimide adhesives, plastisols, or polyvinyl acetate adhesives. Exemplary thermoplastic polymers include polypropylene, polyethylene, polybutylene, polyisoprene and polyolefin copolymers thereof.

Flow channel ends may be selectively heated to fuse the flow channel end and to provide a rigid mechanical frame, mounting surfaces and/or flow manifold mating surfaces for the membrane separation module. By sealing the corners and peripheral edges of the membrane separation module, fluid leaks and cross-contamination of fluids can be minimized, as well as provide a smooth surface for gasket seals or fluid manifold interfaces. In some embodiments, the sealing of the corners and peripheral edges of the membrane separation module also provide additional structural strength and/or provide a rigid mechanical framework to support the bonded stack. When at least a significant portion of the support sheets are made of thermoplastic polymers, all or a portion of one or more faces of the membrane separation unit may be fused or “face melted” by pressing it against a heated plate or platen. This is accomplished by face melting or fusing the face of the membrane separation module and then cutting or milling a recess into the face. See U.S. Appl. No. 61/702,942, filed 19 Sep. 2012 for more details.

The membrane separation module may be placed into a housing and/or connected with a fluid distribution cap to direct fluid into the membrane separation module and contain the fluid.

Articles of the present disclosure include: a normal flow or tangential flow filtration device, a liquid/liquid contactor, a liquid/liquid extractor, a liquid/air contactor, a liquid gasification or de-gasification device, a gas-gas separation device, a membrane distillation device, a heat exchanger, or a combination thereof.

In one embodiment, a tangential flow liquid contactor, providing for crossflow contact of a liquid stream and a gas stream on opposing sides of a series of membranes may be constructed. Such a contactor might be useful, for example, for the dehumidification of a humid air stream, flowing through the contactor in a first flow direction, by transport of water vapor across a series of hydrophobic, microporous membranes and into a liquid desiccant solution flowing through the contactor in a second flow direction.

Exemplary embodiments of the present disclosure include:

### Embodiment 1

A construction comprising:

(a) a support sheet having a base, comprising
(i) a plurality of rails extending from the base wherein each rail of the plurality of rails extends continuously down a length of the support sheet and each rail comprises a first side surface and an opposing second side surface and a top surface; and
(ii) a plurality of first protrusions extending from the base, wherein the plurality of first protrusions are located between the plurality of rails; and
(b) a selectively permeable membrane having a first major membrane surface contacting at least the top surface of at least two rails enclosing a flow channel having a height extending between the base of the support sheet and the first major membrane surface, wherein the plurality of protrusions change the height of the flow channel along its length along the longitudinal axis of the flow channel.

### Embodiment 2

The construction of embodiment 1, wherein a protrusion of the plurality of first protrusions is discontinuous along the longitudinal axis of the flow channel.

### Embodiment 3

construction of any one of the previous embodiments, wherein a protrusion of the plurality of first protrusions comprises at least one leading edge which is oriented in a direction not substantially parallel with the longitudinal axis of the flow channel.

### Embodiment 4

construction of any one of the previous embodiments, wherein a protrusion of the plurality of first protrusions comprises a height, h3 and the distance between the base and the first major surface of the selectively permeable membrane is height h1 wherein h3 is less than 80% of h1.

### Embodiment 5

construction of any one of the previous embodiments, wherein the flow channel has a least one of a width or an average height greater than 1000 μm.

### Embodiment 6

construction of any one of the previous embodiments, wherein a protrusion of the plurality of first protrusions extends continuously from the first side surface of the rail to the opposing side surface of an adjacent rail.

### Embodiment 7

construction of any one of the previous embodiments, wherein the plurality of first protrusions are a series of substantially parallel projections arranged at an angle with respect to the longitudinal axis of the flow channel.

### Embodiment 8

construction of any one of the previous embodiments, wherein the plurality of first protrusions form a substantially herringbone-like pattern.

### Embodiment 9

construction of any one of the previous embodiments, further comprising a plurality of second protrusions, wherein the plurality of second protrusions are oriented in a direction substantially parallel with the longitudinal axis of the flow channel.

### Embodiment 10

construction of embodiment 9, wherein a protrusion of the plurality of second protrusions comprises a curvilinear profile in the direction of the longitudinal axis of the flow channel.

### Embodiment 11

construction of any one of the previous embodiments, wherein a protrusion in the plurality of first protrusions have a height between 50 and 500 micrometers.

### Embodiment 12

construction of any one of the previous embodiments, wherein the selectively permeable membrane is selected at least one of: microfiltration membranes, ultrafiltration membranes, nanofiltration membranes, reverse osmosis membranes, ionic polymer membranes, composite membranes containing ionic liquids, nonwoven or woven webs, and perforated polymer films.

### Embodiment 13

construction of any one of the previous embodiments, wherein the first side surface and the second side surface comprise a thermoplastic polymer.

### Embodiment 14

construction of embodiment 13, wherein the thermoplastic polymer is selected from at least one of: polypropylene and copolymers thereof, polyethylene and copolymers thereof, polyolefin elastomers, ethylene vinyl acetate copolymers, ethylene vinyl acetate terpolymers, styrene-ethylene/butylene-styrene block copolymers, polyurethanes, polybutylene, polybutylene copolymers, polyisoprene, polyisoprene copolymers, acrylate, silicones, natural rubber, polyisobutylene, butyl rubber, and mixtures thereof.

### Embodiment 15

construction of any one of the previous embodiments, wherein a protrusion of the plurality of first protrusions is discontinuous from the first side surface to the opposing side surface of an adjacent rail.

### Embodiment 16

construction of any one of the previous embodiments, wherein a protrusion of the plurality of first protrusions is positioned at an intermediate location between the first side surface and opposing side surface of an adjacent rail and the flow channel comprises a tortuous path comprising flow restrictions positioned along the flow channel between the inlet and the outlet wherein the open cross-sectional area of the flow channel decreases and increases when moving along the longitudinal axis of the flow channel.

### Embodiment 17

A fluid membrane separation module comprising:

a series of repeating layers, each layer comprising the construction of any one of embodiments 1-16.

### Embodiment 18

membrane separation module of embodiment 17, wherein the net flow path in the flow channels on either side of each selectively permeable membrane are substantially orthogonal to one another.

### Embodiment 19

membrane separation module of any one of embodiments 17-18, wherein the first major surface of the selectively permeable membrane is bonded to the top surface of at least two rails to form a bonded stack.

### Embodiment 20

A method of a making membrane construction comprising:

(a) providing a nip roll comprising a negative of a design;

(b) extruding a polymer through a nip comprising the nip roll to impart the design into the first major surface of the polymer to create a support sheet having a design on the first major surface;

(c) contacting the first major surface of the support sheet with a selectively permeable membrane to form the membrane construction.

### Embodiment 21

The method of embodiment 20, wherein the first major surface of the support sheet is adhesively contacted with the selectively permeable membrane.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

These abbreviations are used in the following examples: g=gram, kg=kilograms, min=minutes, mol=mole; μm=micrometer; cm=centimeter, mm=millimeter, mil=one thousandth of an inch; ml=milliliter, L=liter, psi=pounds per square inch, MPa=megaPascals, and wt=weight.

Support Sheets

Support sheets 1-3 and Comparative Support Sheet A were fabricated using a stereolithographic system marketed under the trade designation “VIPER SLA” by Kallisto (Toulouse, France). Briefly, a computer controlled laser cures a photo-sensitive resin layer by layer to create a 3-dimensional object. The photosensitive resin used in these examples was an ABS (acrylonitrile butadiene styrene)-like photopolymer available under the trade designation “SOMOS WATERSHED XC 11122” available from DSM Corp., Elgin, Ill.

Comparative Support Sheet B and C were fabricated by passing the polycarbonate through an extruder equipped with a die lip having the desired shaping profile. For further details, see for example U.S. Prov. Pat. Appl. No. 61/702,942 (Henderson et al.).

Comparative Support Sheet A is an 8 in×8 in×0.040 in thick (approximately 20 cm×20 cm×1 mm) sheet of the SOMOS WATERSHED XC 11122 having a plurality of flow channels formed by a plurality of rails as shown in FIG. 8. Each rail is 26 mils (660 μm) high and 6 mils (152 μm) wide with a distance of 70 mils (1.78 mm) between rails, measured from the center of one rail to the center of an adjacent rail.

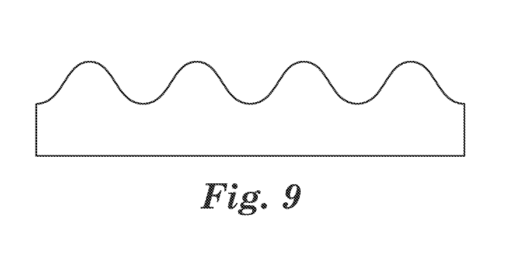

Comparative Support Sheet B is an 8 in×8 in×0.040 in thick (approximately 20 cm×20 cm×1 mm) sheet of polycarbonate having a plurality of flow channels formed by the peaks and valleys of a sine wave as shown in FIG. 9. The sinusoidal structure has a wavelength of 0.141 inches (0.36 cm) and an amplitude of 0.055 inches (0.14 cm).

Comparative Support Sheet C is an 8 in×8 in×0.040 in thick (approximately 20 cm×20 cm×1 mm) sheet of polycarbonate having a plurality of flow channels formed by the peaks and valleys of a sine wave as shown in FIG. 9. The sinusoidal structure has a wavelength of 0.0705 inches (0.18 cm) and an amplitude of 0.028 inches (0.71 mm)

Comparative Support Sheet D is a biplanar net used to create turbulent vortices (28 mils (711 μm) thick available under the trade designation “NALTEX” from Delstar Technologies, Inc., Middletown, Del.) and was cut to an 8 in by 8 in (approximately 20 cm×20 cm) sheet.

Comparative Support Sheet E: Woven biplanar net used to create turbulent vortices (17 mils (432 μm) from Delstar Technologies, Inc., Middletown, Del.) thick and was cut to a 8 in by 8 in (approximately 20 cm×20 cm) sheet.

Support Sheet 1 is an 8 in×8 in×0.040 in thick (approximately 20 cm×20 cm×1 mm) sheet of the SOMOS WATERSHED XC 11122 having a plurality of flow channels formed by a plurality of linear rails and a plurality of first protrusions at the bottom of each flow channel. The protrusions are projections diagonal to the direction of the rail. FIG. 2 shows a schematic of Support Sheet 1. Each rail is 30 mils (762 μm) high (h₁) and 6 mils (152 μm) wide (wᵣ) with a distance of 70 mils (1.78 mm) between rails, measured from the center of one rail to the center of an adjacent rail. The projections were at a 45 degree angle from the direction of the rail. The projections were 6.66 mils (169 μm) wide (wₚ) and 6 mils (152 μm) high (h₃), with 6.66 mils (169 μm) (w) between each protrusion. The mean flow channel height in Support Sheet 1, accounting for the difference in channel height between the grooves and protrusions between the grooves is approximately 0.027 inches (686 μm).

Support Sheet 2 is the same as Support Sheet 1, except, it further comprises a plurality of second protrusions in each flow channel, wherein the second protrusions are discontinuous, running parallel to the rails as shown in FIG. 3. The second protrusions are 6 mils (152 μm) wide (wₚ) and 103.68 mils (2.63 mm) long in the longitudinal axis direction. The second protrusions are situated midway across the width of the flow channel. There is approximately 35 mils (889 μm) from the center of the second protrusion to the center of the adjacent rail. The second protrusions run discontinuously down the length of the flow channel with 103.68 mils (2.63 mm) between the end of one second protrusion and the start of an adjacent second protrusion. The mean flow channel height in Support Sheet 2, accounting for the difference in channel height between the grooves and protrusions between the grooves is approximately 0.027 inches (686 μm).

Support Sheet 3 is an 8 in×8 in×0.040 in thick (approximately 20 cm×20 cm×1 mm) sheet of the SOMOS WATERSHED XC 11122 having a plurality of flow channels formed by a plurality of linear rails and a plurality of first protrusions at the bottom of each flow channel. The protrusions are projections formed in a staggered herringbone configuration as shown in FIG. 4. Each rail is 30 mils (762 μm) high (h₁) and 6 mils (152 μm) wide (wᵣ) with a distance of 70 mils (1.78 mm) between rails, measured from the center of one rail to the center of an adjacent rail. The projections were 6.66 mils (169 μm) wide (wₚ) and 6 mils (152 μm) high (h₃), with 6.66 mils (169 μm) between each groove (w). The grooves were at a 45 degree angle from the direction of the rail. The distance l is 24.33 mils (618 μm). The mean flow channel height in Support Sheet 3, accounting for the difference in channel height between the grooves and protrusions between the grooves is approximately 0.027 inches (686 μm).

Support Sheet 4 is an 8 in×8 in×about 0.080 in thick (approximately 20 cm×20 cm×2 mm) sheet of SOMOS WATERSHED XC 11122 having a plurality of flow channels comprising flow restrictions and flow perturbation members shown in FIG. 6. The flow channel changes in both width and in height across the longitudinal axis. The height, h₁ is 1 mm, however, in addition to the protrusions, the bottom of the flow channel (or base of the support sheet) comprises an undulating pattern in the longitudinal direction comprising parabolic ridges having a peak height of approximately 0.7 to 0.75 mm and length along the longitudinal axis of 2.5 mm with approximately 2 to 2.5 mm between the parabolic ridges. The plurality of protrusions extend from the bottom of the flow channel and comprise varying heights (between 0.5 mm to 0.8 mm) and widths. The approximate volume of the flow channel is 10 mm³ per element with the protrusions extending from the first side surface and opposing side surface of the rails comprising about 12% of the volume and the plurality of protrusions extending from the base comprising about 8% of the volume.

Selectively Permeable Membrane 1 is a polypropylene membrane made by the thermally induced phase separation (TIPS) process as described in U.S. Pat. No. 4,726,989 (Mrozinski). The membrane has a thickness of 15.2 m (0.6 mils), a porosity of 63%, and a bubble point pore diameter of 0.13 m. The membrane was cut to size prior to use.

Selectively Permeable Membrane 2 is a polysulfone membrane, 0.165 mm thick, having a 20 kiloDalton molecular weight cutoff (PS-35 available from Sepro Membranes, Inc., Oceanside, Calif.). The membrane was cut to size prior to use.

Testing System: A stack (comprising a selectively permeable membrane sandwiched between two support sheets) is placed in a holder to form a testing apparatus. The holder comprises two 8-inch by 8-inch (20.3×20.3 cm) polycarbonate endplates. Each endplate was machined to have a receiving recess or “pocket” having a depth equal to the thickness of the desired support sheet, into which a support sheet could be inserted. Each endplate had two opposing holes functioning as a fluid inlet and fluid outlet. The endplates comprising the stack therebetween were then screwed together. The holder should be sealed such that the only fluid communication between the two support sheets occurs through the selectively permeable membrane. The testing apparatus is then placed in a system comprising a first gear pump providing for circulation of a first fluid from a first reservoir, to the test apparatus, and back to the first reservoir; and a second gear pump providing for circulation of a second fluid from a second reservoir, to the test apparatus, and back to the second reservoir.

### Example 1

### Efficiency of Extracting Ethanol From an Aqueous Solution

A stack was made comprising a Support Sheet B, the Selectively Permeable Membrane 1, and a second support sheet. Support Sheet B was configured such that the apexes of the sinusoidal structure were next to the Selectively Permeable Membrane 1. For the second support sheet various support sheets as disclosed in Table 1 were used. If the support sheet comprised rails, the rails were placed such that they were next to the Selectively Permeable Membrane 1. The support sheets were oriented such that the net fluid flow on either side of the permeable membrane was tangential. In other words, the net fluid flows on opposite sides of the selectively permeable membrane were substantially perpendicular. The selectively permeable membrane provided for fluid communication between the aqueous liquid flowing along Support Sheet B and the extraction solvent flowing along the second support sheet.

The stack was placed inside the holder and the Testing System described above was used. An aqueous solution comprising 11.5% ethanol by weight (herein referred to as the “aqueous phase”) was delivered to the Support Sheet B side via the inlet and was pumped through the testing apparatus. A water-immiscible extraction solvent (available under the trade designation “EXXAL 8” by ExxonMobil Chemical Co., Houston, Tex., herein referred to as the “extraction phase”) comprising 1.0 to 1.6 wt % ethanol was used as the extraction solvent and was delivered to the second support sheet side of the test apparatus. The aqueous and extraction phases were pumped through the testing apparatus at the rates shown in Table 1 below. The Experiment was run at 23° C. The concentration of ethanol in the aqueous solution and the extraction solution was monitored during the experiment by gas chromatography and the ethanol mass transfer coefficient was determined. The pressure drop on the aqueous side of the testing apparatus was monitored using a pressure transducer positioned at the inlet and outlet of the polycarbonate holder. The results are shown in Table 1 below.

TABLE 1

| Support | Aqueous | Extraction | Mass | Pressure |
|---|---|---|---|---|
| sheet used | Phase | Phase | Transfer | drop per |
| on solvent | Flow rate | Flow rate | Coefficient | unit length |
| side | (cm/s) | (cm/s) | (cm/s) | (psi/ft) |
| A | 1.2 | 1.1 | 7.03 × 10⁻⁵ | 0.32 |
| B | 1.2 | 1.1 | 7.09 × 10⁻⁵ | 0.15 |
| C | 1.77 | 1.4 | 8.10 × 10⁻⁵ | 0.41 |
| D | 1.2 | 1.1 | 1.10 × 10⁻⁴ | 0.45 |
| E | 1.2 | 1.1 | 1.22 × 10⁻⁴ | 9.89 |
| 1 | 1.2 | 1.1 | 9.30 × 10⁻⁵ | 0.35 |
| 2 | 1.2 | 1.1 | 1.05 × 10⁻⁴ | 0.35 |
| 3 | 1.2 | 1.1 | 1.02 × 10⁻⁴ | Not |
| | | | | measured |

### Example 2

### Protein Fouling Resistance

A stack was made comprising a woven textile permeate-side support sheet (Guilford Mills Tricot available from Guilford Mills Inc., Greensboro, N.C.), Selectively Permeable Membrane 2, and a feed-side support sheet. For the feed-side support sheet, various support sheets as disclosed in Table 1 were used. If the support sheet comprised rails, the rails were placed such that they were next to Selectively Permeable Membrane 2. The support sheets were oriented such that the net fluid flow on either side of the permeable membrane was tangential.

A testing apparatus was configured comprising a feed fluid inlet and a retentate fluid outlet on one side of the selectively permeable membrane, and two permeate fluid outlets on the opposite side of the selectively permeable membrane. The feed fluid was made to flow along the feed-side support sheet from a first end of the support sheet to a second end of the support sheet. A first portion of the feed fluid, the retentate fluid, reached the second end of the feed-side support sheet without permeating the membrane, and was withdrawn from the testing apparatus through the retentate fluid outlet. A second portion of the feed fluid, the permeate fluid, permeated the membrane and entered the permeate-side support sheet, wherein it was able to travel to the permeate outlets and was withdrawn from the testing apparatus.

The stack was placed inside the holder and the Testing System described above was used. A 0.1 wt % bovine serum albumin (BSA) in an aqueous phosphate buffered saline (PBS) solution was delivered to the feed-side support sheet side via the inlet at an inlet flow rate, Qᵢ, and was pumped through the testing apparatus. A portion of the fluid passes through the selectively permeable membrane to the permeate side and exits the outlet of the second polycarbonate endplate at a permeate flow rate, Qₚ. Another portion of the fluid was retained on the retentate side and exited the cell through the retentate-side outlet at a retentate flow rate, Qᵣ. The “recovery” was calculated as: (Qₚ/Qᵢ)×100%.

Before testing the fouling characteristics using the various support sheets, the Selectively Permeable Membrane 2 was wetted in an aqueous solution of 60% by volume of isopropyl alcohol for no less than one hour. The Selectively Permeable Membrane 2 was then mounted in the reusable polycarbonate module and PBS was cycled through the module until a steady-state trans-membrane pressure (TMP) was reached. After this membrane conditioning period, the relationship between membrane flux and trans-membrane pressure was determined for operation with pure PBS, which provides information about the membrane's behavior under no-fouling conditions. Since no foulant was in this solution, the relationship between flux and trans-membrane pressure was linear.

The fouling characteristics of each membrane construction were subsequently determined using a flux-stepping method that is common in the academic literature. The starting recovery was 4-5%, and the step length was 10 minutes. These parameters were consistent across all tests. The feed rate for each fouling test was held constant by a computer-controlled gear pump. Feed and retentate flow rates were measured using turbine flow meters.

Each fouling test began with steady-state operation of the module at 4-5% recovery with 3600 mL of clean PBS. 400 mL of 1 wt % BSA in PBS was then added to the feed reservoir, resulting in a 0.1 wt % solution of BSA in PBS. Addition of the foulant solution typically resulted in a small increase in TMP, so the module was allowed to reach a steady-state TMP before continuing with the test. The recovery (and thus the flux through the membrane) was then increased by a small amount and the module was allowed to operate at these new conditions for 10 minutes. The amount of flux increase, or the “step height”, was changed for each feed rate, but was consistent for each run at the same feed flow rate. The flux was increased by discrete steps in this way until significant deviation from a linear flux-TMP relationship was observed. Average values of flux and trans-membrane pressure were extracted from each of these steps and were then used to build a curve relating the flux through the membrane with the associated trans-membrane pressure. The relationship between TMP and membrane flux is typically linear at low values of the recovery. At higher values of the recovery, this relationship departs from linearity (i.e., each upward increment of the TMP results in an ever decreasing upward increment of the flux) as significant membrane fouling occurs. The value of the flux at which this departure from linearity occurs is known as the “critical flux.” The critical flux was defined as the flux at which the ratio of flux to TMP departed from linearity by more than 5 percent.

Critical flux data was obtained for each spacer (support sheet) at several feed flow rates. Low feed flow rates (100 mL/min) were selected to produce laminar flow in the feed channel, while high feed flow rates (400 mL/min) were selected to induce turbulent flow. Moderate feed flow rates (250 mL/min) likely produced fluid flow in the transitional flow regime. A summary of the critical flux data for several spacers (support sheets) in different flow regimes is shown in Table 2 below.

TABLE 2

| Feed-side | Feed Flow Rate (mL/min) | | | |
|---|---|---|---|---|
| Support | Laminar -------------------------------------------------- Turbulent | | | |
| Sheet | 50 | 100 | 250 | 400 |
| 4 | 21.9 | 31.2 | 36.3 | 33.5 |
| D | * | 19.9 | 35.1 | 33.2 |
| 1 | 11.1 | 20.9 | 23.7 | 24.8 |
| 3 | Not | 11.7 | 20.3 | 22.2 |
| | measured | | | |
| No | Not | 9.7 | 14.0 | 19.5 |
| support | measured | | | |
| sheet used | | | | |

* Comparative Support Sheet D was tested at a flow rate of 50 mL/min, but a linear flux-TMP relationship with a feed rate of 50 mL/min, which corresponds to a zero critical flux was not exhibited when Support Sheet D was used. This implies that, in this configuration, the testing apparatus comprising Support Sheet D is incapable of sustained use with feed rates at and below 50 mL/min.

*Comparative Support Sheet D was tested at a flow rate of 50 mL/min, but a linear flux-TMP relationship with a feed rate of 50 mL/min, which corresponds to a zero critical flux was not exhibited when Support Sheet D was used. This implies that, in this configuration, the testing apparatus comprising Support Sheet D is incapable of sustained use with feed rates at and below 50 mL/min.

When no support sheet was present to induce mixing in the feed channel-side of selectively permeable membrane, the critical flux behaved as expected and increased moderately with the feed flow rate. When Support Sheet 1 and 4 were present in the feed channel-side of testing apparatus, critical fluxes at the lowest flow rate of 50 mL/min were measurable.

Comparative Support Sheet D is a commercially available net used in filtration applications. Support Sheet 4 had comparable results to Comparative Support Sheet D in turbulent and transitional flow and exceeded the Comparative Support Sheet D's performance in laminar flow. Support Sheet 1 exhibited lower critical fluxes than the Comparative Support Sheet D in turbulent and transitional flow, but met or exceeded the Comparative Support Sheet D's performance in laminar flow.

Other modifications and variations to the present disclosure may be practiced by those of ordinary skill in the art, without departing from the spirit and scope of the present disclosure, which is more particularly set forth in the appended claims. It is understood that aspects of the various embodiments may be interchanged in whole or part or combined with other aspects of the various embodiments. All cited references, patents, or patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A construction wherein the construction is a particle filter, a liquid/gas extractor, or a gas/gas extractor, the construction comprising:
(a) a support sheet having a base, comprising
(i) a plurality of rails extending from the base wherein each rail of the plurality of rails extends continuously down a length of the support sheet and each rail comprises a first side surface and an opposing second side surface and a top surface; and
(ii) a plurality of first protrusions extending from the base, wherein the plurality of first protrusions are located between the plurality of rails and wherein a protrusion of the plurality of first protrusions comprises at least one leading edge which is oriented in a direction not substantially parallel with the longitudinal axis of the flow channel; and
(b) a selectively permeable membrane having a first major membrane surface contacting at least the top surface of at least two rails enclosing a flow channel having a height extending between the base of the support sheet and the first major membrane surface, wherein the plurality of protrusions change the height of the flow channel along its length along the longitudinal axis of the flow channel wherein the selectively permeable membrane contacts a first fluid on the first major membrane surface and a second fluid on a second major membrane surface, wherein the first major membrane surface is opposite the second major membrane surface, and wherein at least one of the first fluid and second fluid is a gas.

2. The construction of claim 1, wherein a protrusion of the plurality of first protrusions is discontinuous along the longitudinal axis of the flow channel.

3. (canceled)

4. The construction of claim 1, wherein a protrusion of the plurality of first protrusions comprises a height, h₃ and the distance between the base and the first major surface of the selectively permeable membrane is height h₁ wherein h₃ is less than 80% of h₁.

5. The construction of claim 1, wherein the flow channel has a least one of a width or an average height greater than 1000 μm.

6. The construction of claim 1, wherein the plurality of first protrusions are a series of substantially parallel projections arranged at an angle with respect to the longitudinal axis of the flow channel.

7. The construction of claim 1, further comprising a plurality of second protrusions, wherein the plurality of second protrusions are oriented in a direction substantially parallel with the longitudinal axis of the flow channel.

8. The construction of claim 1, wherein a protrusion of the plurality of first protrusions is positioned at an intermediate location between the first side surface and opposing side surface of an adjacent rail and the flow channel comprises a tortuous path comprising flow restrictions positioned along the flow channel between the inlet and the outlet wherein the open cross-sectional area of the flow channel decreases and increases when moving along the longitudinal axis of the flow channel.

9. A fluid membrane separation module comprising:
a series of repeating layers, each layer comprising the construction of claim 1.

10. The membrane separation module of claim 9, wherein the net flow path in the flow channels on either side of each selectively permeable membrane are substantially orthogonal to one another.

11. A method of a making membrane construction comprising:
(a) providing a nip roll comprising a negative of a design;
(b) extruding a polymer through a nip comprising the nip roll to impart the design into the first major surface of the polymer to create a support sheet having a design on the first major surface;
(c) contacting the first major surface of the support sheet with a selectively permeable membrane to form the membrane construction, wherein the selectively permeable membrane contacts a first fluid on the first major membrane surface and a second fluid on a second major membrane surface, wherein at least one of the first fluid and second fluid is a gas.

12. The construction of claim 1, wherein a protrusion of the plurality of first protrusions extends continuously from the first side surface of the rail to the opposing side surface of an adjacent rail.

13. The construction of claim 1, wherein the plurality of first protrusions form a substantially herringbone-like pattern.

14. The construction of claim 7, wherein a protrusion of the plurality of second protrusions comprises a curvilinear profile in the direction of the longitudinal axis of the flow channel.

15. The construction of claim 1, wherein a protrusion in the plurality of first protrusions have a height between 50 and 500 micrometers.

16. The construction of claim 1, wherein the selectively permeable membrane is selected at least one of: microfiltration membranes, ultrafiltration membranes, nanofiltration membranes, reverse osmosis membranes, ionic polymer membranes, composite membranes containing ionic liquids, nonwoven or woven webs, and perforated polymer films.

17. The construction of claim 1, wherein the first side surface and the second side surface comprise a thermoplastic polymer.

18. The construction of claim 17, wherein the thermoplastic polymer is selected from at least one of: polypropylene and copolymers thereof, polyethylene and copolymers thereof, polyolefin elastomers, ethylene vinyl acetate copolymers, ethylene vinyl acetate terpolymers, styrene-ethylene/butylene-styrene block copolymers, polyurethanes, polybutylene, polybutylene copolymers, polyisoprene, polyisoprene copolymers, acrylate, silicones, natural rubber, polyisobutylene, butyl rubber, and mixtures thereof.

19. The construction of claim 1, wherein a protrusion of the plurality of first protrusions is discontinuous from the first side surface to the opposing side surface of an adjacent rail.

20. The membrane separation module of claim 9, wherein the first major surface of the selectively permeable membrane is bonded to the top surface of at least two rails to form a bonded stack.
